(19) United States
(12) Patent Application Publication
(10) Pub. No.: US 2007/0236842 A1
(43) Pub. Date: Oct. 11, 2007

(54) Electrostatic discharge protection circuit

(75) Inventor: Nak-Heon Choi, Kyoungki-do (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Hynix Semiconductor Inc.

(21) Appl. No.: 11/400,143

(22) Filed: Apr. 7, 2006

(51) Int. Cl. H02H 9/00

(52) U.S. Cl. 361/56

(57) ABSTRACT

It is provided an electrostatic discharge (ESD) protection circuit capable of discharging an ESD with enhanced reliability. The ESD protection circuit includes an ESD discharge unit for discharging the ESD in response to a trigger voltage, an ESD detection voltage generating unit for providing an ESD detection voltage in response to AC characteristics of the ESD and a trigger voltage generating unit for producing the trigger voltage in response to the ESD detection voltage to thereby activate the ESD discharge unit.

### FIELD OF THE INVENTION

The present invention relates to a semiconductor device; and, more particularly, to a circuit for protecting the semiconductor device from ESD.

### DESCRIPTION OF RELATED ARTS

An electrostatic discharge (ESD) is an electric current driven by an excess electric charge stored on an electrically insulated object. The ESD is one of the factors to test a reliability of a semiconductor device. The ESD breaks out and damages the semiconductor device when the semiconductor device is put into a system or carried from one place to other places by a human. If an electrically insulated human or mechanical device contacts the semiconductor device, a momentary unwanted current by the ESD flows from the human or the mechanical device into the semiconductor device and then, internal circuits of the semiconductor device can be destroyed.

There are three test models about the occurrence of ESD, i.e., the human body model (HBM), the machine model (MM) and the charge device model (CDM). Each test model corresponds to a simple equivalent circuit. For example, a test circuit called the human body model consists of a capacitor in series with a resistor.

Generally, the semiconductor device has an ESD protection circuit in order to protect its internal circuits of the semiconductor device from the ESD. The ESD protection circuit is placed in an input/output region of the semiconductor device. Therefore, in an input/output region of the semiconductor device, there is included the ESD protection circuit besides an input/output circuit for inputting or outputting data. In many cases, the input/output circuit also takes a role as a circuit to protect the internal circuits from the ESD.

The data input to or output from the semiconductor device is through input/output pads. The input/output pads have typically a parasitic capacitance. The parasitic capacitance of the input/output pad has a bad effect on a data input/output operation of the semiconductor device. Thus, it is necessary to reduce the parasitic capacitance of the input/output pad in order to operate the semiconductor device with high speed.

Generally, as the ESD protection circuit is coupled to the input/output pad of the semiconductor device, the parasitic capacitance of the input/output pad becomes larger. As a result, the speed of data access of the semiconductor device can be reduced. That is, the larger area of the ESD protection circuit becomes, the larger parasitic capacitance of the input/output pad. In order to overcome the problem, the ESD protection circuit should be designed to have a minimum circuit area as well as having an enhanced ability to protect the internal circuits from the ESD.

A representative ESD protection circuit having a relatively small area and an ability to effectively protect the internal circuit from the ESD is a silicon controlled rectifier (SCR).

FIG. 1 is a schematic circuit diagram showing a conventional ESD protection circuit, especially, SCR.

As shown in FIG. 1, the conventional ESD protection circuit includes an SCR circuit 101 and an MOS transistor 102. The SCR circuit 101 includes a PNP bipolar transistor T1, an NPN bipolar transistor T2 and a resistor R. Herein, the MOS transistor 102 furnishes a trigger voltage VTR to operate the SCR 101.

Hereinafter, it is explained an operation of the conventional ESD protection circuit.

Once the ESD breaks out and is inputted to an input/output pad I/O, the MOS transistor 102 is turned on and provides the trigger voltage generated to the SCR circuit 101. Then, the bipolar transistors T1 and T2 are turned on in response to the trigger voltage VTR and the ESD passes through the bipolar transistors T1 and T2. That is, the SCR circuit 101 is enabled by the trigger voltage VTR.

After the SCR circuit 101 is triggered when the ESD occurred and is inputted thereto, the SCR circuit 101 operates at relatively low voltage. When the SCR circuit 101 discharges the ESD, all areas of the SCR circuit 101 uniformly contribute to the discharge of the ESD. Therefore, the SCR circuit 101 is not damaged by thermal energy caused during the discharge of the ESD.

However, a trigger voltage of the SCR circuit is higher than that of a general ESD protection circuit without a SCR circuit.

Therefore, there have been developed many techniques of lowering the trigger voltage of the SCR circuit. One of them is shown. The ESD protection circuit in FIG. 1 includes the MOS transistor 102 and the trigger voltage VTR generated by the MOS transistor 102 is transferred to the SCR circuit 101. Because the trigger voltage VTR is determined by a threshold voltage level of the MOS transistor 102, the trigger voltage VTR of the SCR circuit 101 can be lowered substantially.

The ESD protection circuit in FIG. 1 was published by Russ at the symposium ‘EOSESD’ in 2001. The ESD protection circuit by Russ has a trigger voltage having a level of a threshold voltage of an n-channel MOS transistor and can protect the internal circuits from the ESD effectively.

However, since the trigger voltage of the ESD protection circuit is determined in response to only the trigger voltage VTR, if the trigger voltage VTR is not generated by the ESD, the ESD protection circuit cannot discharge the ESD. That is to say, if the MOS transistor 102 is not turned on, the ESD protection circuit does not operate and thus, the internal circuit of the semiconductor device cannot be protected from the ESD.

### SUMMARY OF THE INVENTION

It is, therefore, an object of the present invention to provide an ESD protection circuit using a silicon controlled rectifier (SCR) with enhanced reliability.

In accordance with an aspect of the present invention, there is provided an ESD protection circuit including: an ESD discharge unit for discharging an ESD in response to a trigger voltage; an ESD detection voltage generating unit for producing an ESD detection voltage in response to AC characteristics of the ESD; and a trigger voltage generating unit for producing the trigger voltage in response to the ESD detection voltage to thereby activate the ESD discharge unit.

In accordance with an another aspect of the present invention, an ESD protection circuit for use in a semiconductor device, comprising: an input/output (I/O) pad; a first diode for discharging a certain part of an ESD inputted from the input/output pad to a power supply voltage terminal; a second diode for discharging the certain part of the ESD inputted from the I/O pad to a ground voltage terminal; an ESD discharge unit for discharging a remaining part of the ESD inputted through the power supply voltage terminal or the ground voltage terminal in response to a trigger voltage; a ESD detection voltage generating unit for producing an ESD detection voltage in response to AC characteristics of the ESD; and a trigger voltage generating unit for providing the trigger voltage in response to the ESD detection voltage to thereby activating the ESD discharge unit.

### BRIEF DESCRIPTION OF THE DRAWINGS

The above and other objects and features of the present invention will become apparent from the following description of preferred embodiments taken in conjunction with the accompanying drawings, in which:

FIG. 1 is a schematic circuit diagram showing a conventional electrostatic discharge (ESD) protection circuit;

FIG. 2 is a schematic circuit diagram showing an ESD protection circuit in accordance with a first embodiment of the present invention;

FIG. 3 is a schematic circuit diagram showing an ESD protection circuit in accordance with a second embodiment of the present invention; and

FIG. 4 is a schematic circuit diagram showing an ESD protection circuit which is applied to a semiconductor device including a separate input/output pad in accordance with a third embodiment of the present invention.

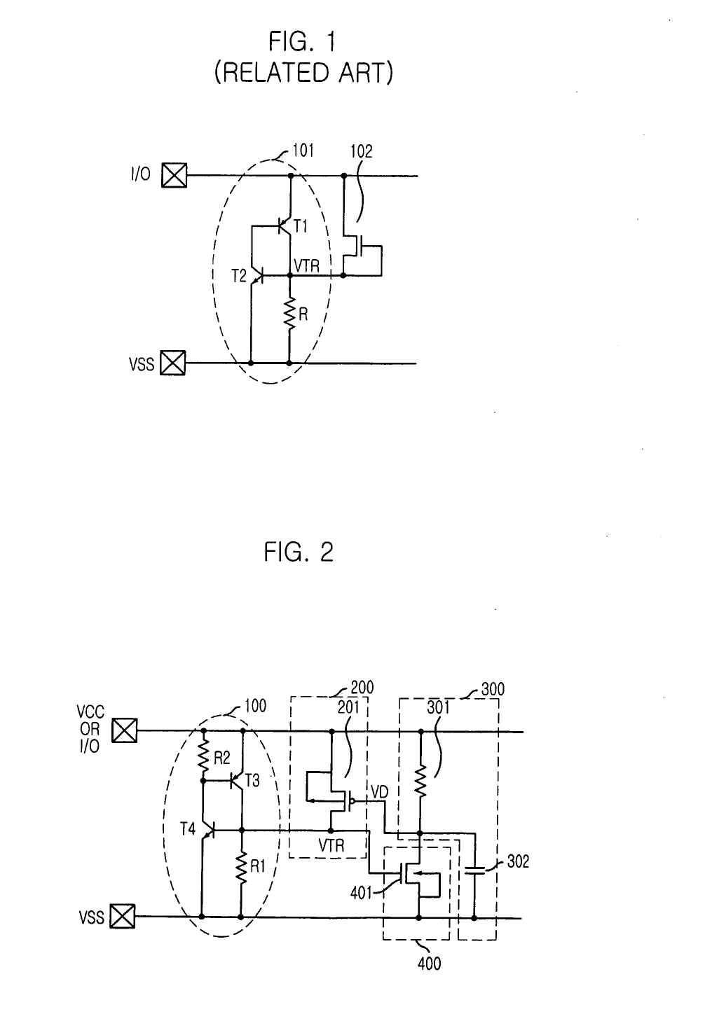

### DETAILED DESCRIPTION OF THE INVENTION

Hereinafter, an ESD protection circuit in accordance with specific embodiments of the present invention will be described in detail referring to the accompanying drawings.

FIG. 2 is a schematic circuit diagram showing an ESD protection circuit in accordance with a first embodiment of the present invention.

As shown in FIG. 2, the ESD protection circuit includes an ESD discharge unit 100 for discharging the ESD inputted through power supply voltage (VCC) or input/output (I/O) pad in response to a trigger voltage VTR, an ESD detection voltage generating unit 300 for producing an ESD detection voltage VD in response to AC characteristics of the ESD and a trigger voltage generating unit 200 for producing the trigger voltage VTR to thereby activate the ESD discharge unit 100 by using the trigger voltage VTR in response to the detection voltage VD.

The ESD discharge unit 100 includes a PNP bipolar transistor T3 having an emitter coupled to the VCC or the I/O pad and a collector coupled to the trigger voltage VTR, an NPN bipolar transistor T4 having a collector coupled to a base of the PNP bipolar transistor T3, an emitter coupled to a ground voltage (VSS) pad and a base coupled to the collector of the PNP bipolar transistor T3, a resistor R1 coupled between the base of NPN bipolar transistor T4 and the VSS pad, and a resistor R2 coupled between the base of the PNP bipolar transistor T3 and the VCC or I/O pad.

The trigger voltage generating unit 200 includes an MOS transistor 201 having one terminal coupled to the VCC or the I/O pad, the other terminal coupled to the trigger voltage VTR and a gate coupled to the ESD detection voltage VD. Herein, the MOS transistor 201 is a P-channel MOS transistor.

The ESD detection voltage generating unit 300 includes a resistor 301 having one terminal coupled to the VCC or the I/O pad and a capacitor 302 having one terminal coupled to the other terminal of the resistor 301 and the other terminal coupled to the VSS pad.

Also, the ESD protection circuit includes an auxiliary ESD detection voltage generating unit 400 for producing the ESD detection voltage VD to be provided to the trigger voltage generating unit 200 in response to DC characteristics of the ESD wherein the auxiliary ESD detection voltage generating unit 400 is enabled in response to the trigger voltage VTR.

The auxiliary detection voltage generating unit 400 includes an MOS transistor 401 having one terminal coupled to the other terminal of the resistor 301, the other terminal coupled to the VSS pad and a gate for receiving the trigger voltage VTR. Herein, the MOS transistor 401 is an N-channel MOS transistor.

As described above, the ESD protection circuit in accordance with the first embodiment of the present invention is coupled between the VCC or I/O pad and the VSS pad. That is to say, one terminal of the resistor 301, the MOS transistor 201 and the resistor R2, and the emitter of the PNP transistor T3 respectively are coupled to the VCC or the input/output pad I/O. If the ESD protection circuit is coupled between the VCC pad and the VSS pad, the ESD protection circuit discharges the current by the ESD inputted through a terminal of the VCC pad. Alternatively, the ESD protection circuit is coupled between the I/O pad and VSS pad, the ESD protection circuit discharges the current by the ESD inputted through a terminal of the I/O pad.

Hereinafter, referring to FIG. 2, the operation of ESD protection circuit in accordance with the first embodiment of the present invention will be explained in detail. Particularly, this description focuses on the case that the ESD protection circuit is coupled between the VCC and VSS pad.

Once an ESD occurs and the ESD is inputted to the the VCC pad, the AC current of the ESD passes from the VCC pad to the VSS pad through the resistor 301 and the capacitor 302. Then, the ESD detection voltage VD is produced at a common node of the resistor 301 and the capacitor 302. Then, because a voltage produced to the gate of the MOS transistor 201 become lower than a threshold voltage of the MOS transistor 201, the MOS transistor 201 is turned on and the trigger voltage VTR is generated to the ESD discharge unit 100. The ESD discharge unit 100 formed as a type of an SCR circuit is enabled by the trigger voltage VTR and discharge the ESD.

The auxiliary ESD detection voltage generating unit 400 is also enabled by the trigger voltage VTR. That is, the MOS transistor 401 is turned on by the trigger voltage VTR.

An AC current of the ESD is produced at an initial period and at an ending period after the ESD occurred. Alternatively a DC current of the ESD is generated between the initial period and an ending period. Once the DC current is produced, the DC current passes from the VCC pad to the VSS pad though the resistor 301 and the MOS transistor 401.

Therefore, during the initial period and the ending period after the ESD occurred, the ESD detection voltage VD is generated by the AC current of the ESD. On the other hand, when an amount of the current of the ESD does not vary between the initial period and an ending period, the ESD detection voltage VD is generated by the DC current of the ESD. Accordingly, the ESD detection voltage VD is stably generated during the whole period for discharging the ESD and the trigger voltage VTR is also stably produced by the ESD detection voltage. As a result, the ESD protection circuit in accordance with the first embodiment of the present invention can discharge the ESD for the whole period ESD occurred.

Also, since the ESD detective voltage generating unit 301 provides the ESD detection voltage VD produced by the resistor 301 and the capacitor 302 to the trigger voltage generating unit 200, the ESD protection circuit in accordance with an embodiment of the present invention can be more quickly enabled than the conventional ESD protection circuit, and can discharge the ESD more quickly.

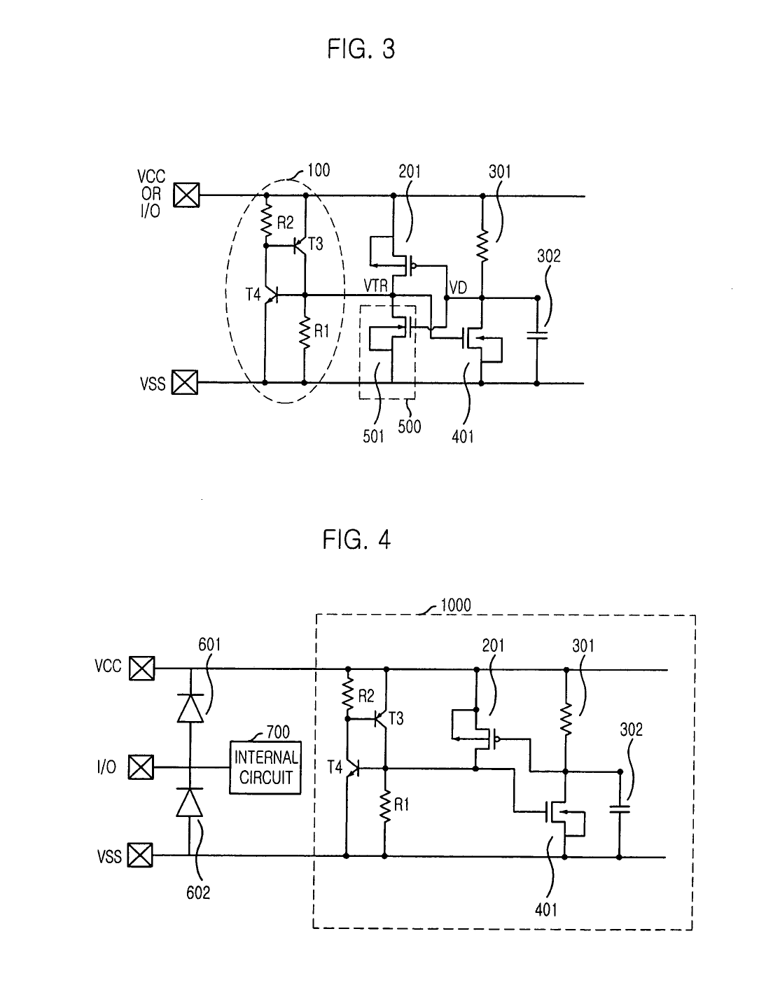

FIG. 3 is a schematic circuit diagram showing an ESD protection circuit in accordance with a second embodiment of the present invention.

As shown in FIG. 3, the ESD protection circuit has substantially the same constitution as the ESD protection circuit in accordance with the first embodiment except for an auxiliary trigger voltage generating unit 500.

The auxiliary trigger voltage generating unit 500 has an MOS transistor 501 having a gate coupled to the gate of the MOS transistor 201, one terminal coupled to the other terminal of the MOS transistor 201 and the other terminal coupled to a ground voltage VSS. Herein, the MOS transistor 501 is an N-channel MOS transistor.

The MOS transistor 501 is turned on when the MOS transistor 201 is turned off. Therefore, the timing in which the ESD detection voltage VD and the trigger voltage VTR are respectively generated becomes faster than that of the ESD protection circuit in accordance with the first embodiment of the present invention.

FIG. 4 is a schematic circuit diagram showing an ESD protection circuit which is applied to a semiconductor device including an separate input/output pad in accordance with a third embodiment of the present invention.

As shown in FIG. 4, the ESD protection circuit includes an input/output (I/O) pad, a first diode 601 coupled between the I/O pad and a VCC pad, a second diode 602 coupled between the I/O pad and a VSS pad, and an ESD discharge unit 1000. Herein, the ESD discharge unit 1000 has the same construction as the first embodiment of the present invention described in FIG. 2. an internal circuit 700 is a circuit for carrying out a main operation of the semiconductor device.

When an ESD occurs and is inputted to I/O pad, the first diode 601 discharges a part of the ESD and transfers a remaining part of the ESD to the VCC pad. Alternatively, the second diode 602 discharges a part of the ESD and transfers a remaining part of the ESD to the VSS pad. The ESD discharge unit 1000 discharges the ESD respectively transferred to the VCC pad and the VSS pad.

That is to say, if the ESD is inputted to the I/O pad, the first and the second diodes 601 and 602 discharge a part of the ESD and transfer a remaining part of the ESD to the VCC pad or the VSS pad and then, the ESD discharge unit 1000 discharges the remaining part of the ESD. Accordingly, the ESD protection circuit in accordance with the third embodiment of the present invention can discharge the ESD more effectively and protect the internal circuit 700 from the ESD with enhanced reliability.

While the present invention has been described with respect to the particular embodiments, it will be apparent to those skilled in the art that various changes and modifications may be made without departing from the spirit and scope of the invention as defined in the following claims.

What is claimed is:

1. An electrostatic discharge (ESD) protection circuit, comprising:
an ESD discharge unit for discharging an ESD in response to a trigger voltage;
an ESD detection voltage generating unit for producing an ESD detection voltage in response to AC characteristics of the ESD; and
a trigger voltage generating unit for producing the trigger voltage in response to the ESD detection voltage to thereby activate the ESD discharge unit.

2. The ESD protection circuit as recited in claim 1, wherein the trigger voltage generating unit includes a first MOS transistor having one terminal coupled to a power supply voltage terminal, the other terminal coupled to a node of the trigger voltage and a gate coupled to a node of the ESD detection voltage.

3. The ESD protection circuit as recited in claim 2, wherein the first MOS transistor is a P-channel MOS transistor.

4. The ESD protection circuit as recited in claim 1, further comprising an auxiliary ESD detection voltage generating unit for providing the detection voltage to the trigger voltage generating unit in response to DC characteristics of the ESD, wherein the auxiliary ESD detection voltage generating unit is enabled in response to the trigger voltage.

5. The ESD protection circuit as recited in claim 4, further comprising an auxiliary trigger voltage generating unit coupled between the trigger voltage generating unit and a ground voltage terminal in order to increase a transition speed of the trigger voltage, wherein the auxiliary trigger voltage generating unit is enabled in response to the ESD detection voltage.

6. The ESD protection circuit as recited in claim 5, wherein the detection voltage generating unit includes:
a resistor having one terminal coupled to a power supply voltage terminal; and
a capacitor having one terminal coupled to the other terminal of the resistor and the other terminal coupled to a ground voltage terminal.

7. The ESD protection circuit as recited in claim 6, wherein the auxiliary ESD detection voltage generating unit includes a second MOS transistor having one terminal coupled to the other terminal of the resistor, the other terminal coupled to the ground voltage terminal and a gate for receiving the trigger voltage.

8. The ESD protection circuit as recited in claim 7, wherein the second MOS transistor is an N-channel MOS transistor.

9. The ESD protection circuit as recited in claim 7, wherein the ESD discharge unit includes:
a PNP bipolar transistor having an emitter coupled to the power supply voltage terminal and a collector coupled to the node of the trigger voltage;
a NPN bipolar transistor having an collector coupled to a base of the PNP bipolar transistor, an emitter coupled to the ground voltage terminal and a base coupled to the collector of the PNP bipolar transistor;
a first resistor coupled between the base of NPN bipolar transistor and the ground voltage terminal; and
a second resistor coupled between the base of PNP bipolar transistor and the power supply voltage terminal.

10. The ESD protection circuit as recited in claim 9, wherein the auxiliary trigger voltage generating unit includes a third MOS transistor having a gate coupled to a node of the ESD detection voltage, one terminal coupled to the node of the trigger voltage and the other terminal coupled to the ground voltage terminal.

11. The ESD protection circuit as recited in claim 10, wherein the third MOS transistor is an N-channel MOS transistor.

12. The ESD protection circuit as recited in claim 1, wherein the trigger voltage generating unit includes a first MOS transistor having one terminal coupled to an input/output (I/O) pad, the other terminal coupled to a node of the trigger voltage and a gate coupled to a node of the ESD detection voltage.

13. The ESD protection circuit as recited in claim 12, wherein the first MOS transistor is a P-channel MOS transistor.

14. The ESD protection circuit as recited in claim 12, further comprising an auxiliary ESD detection voltage generating unit for providing the detection voltage to the trigger voltage generating unit in response to DC characteristics of the ESD, wherein the auxiliary ESD detection voltage generating unit is enabled in response to the trigger voltage.

15. The ESD protection circuit as recited in claim 14, further comprising an auxiliary trigger voltage generating unit coupled between the trigger voltage generating unit and a ground voltage terminal in order to increase a transition speed of the trigger voltage, wherein the auxiliary trigger voltage generating unit is enabled in response to the ESD detection voltage.

16. The ESD protection circuit as recited in claim 15, wherein the ESD detection voltage generating unit includes:
a resistor having one terminal coupled to the I/O pad; and
a capacitor having one terminal coupled to the other terminal of the resistor and the other terminal coupled to the ground voltage terminal.

17. The ESD protection circuit as recited in claim 16, wherein the auxiliary ESD detection voltage generating unit includes a second MOS transistor having one terminal coupled to the other terminal of the resistor, the other terminal coupled to the ground voltage terminal and a gate for receiving the trigger voltage.

18. The ESD protection circuit as recited in claim 17, wherein the second MOS transistor is an N-channel MOS transistor.

19. The ESD protection circuit as recited in claim 17, wherein the ESD discharge unit includes:
a PNP bipolar transistor having an emitter coupled to the I/O pad and a collector coupled to the node of the trigger voltage;
an NPN bipolar transistor having an collector coupled to a base of the PNP bipolar transistor, an emitter coupled to the ground voltage terminal and a base coupled to a base collector of the PNP bipolar transistor;
a first resistor coupled between the base of NPN bipolar transistor and the ground voltage terminal; and
a second resistor coupled between the base of PNP bipolar transistor and the I/O pad.

20. The ESD protection circuit as recited in claim 19, wherein the auxiliary trigger voltage generating unit includes a third MOS transistor having a gate coupled to a node of the ESD detection voltage, one terminal coupled to the node of the trigger voltage and the other terminal coupled to the ground voltage terminal.

21. The ESD protection circuit as recited in claim 20, wherein the third MOS transistor is an N-channel MOS transistor.

22. An electrostatic discharge (ESD) protection circuit, comprising:
an input/output (I/O) pad;
a first diode for discharging a certain part of an ESD inputted from the input/output pad to a power supply voltage terminal;
a second diode for discharging the certain part of the ESD inputted from the I/O pad to a ground voltage terminal;
an ESD discharge unit for discharging a remaining part of the ESD inputted through the power supply voltage terminal or the ground voltage terminal in response to a trigger voltage;
a ESD detection voltage generating unit for producing an ESD detection voltage in response to AC characteristics of the ESD; and
a trigger voltage generating unit for providing the trigger voltage in response to the ESD detection voltage to thereby activate the ESD discharge unit.

23. The ESD protection circuit as recited in claim 22, wherein the trigger voltage generating unit includes a first MOS transistor having one terminal coupled to a power supply voltage terminal, the other terminal coupled to a node of the trigger voltage and a gate coupled to a node of the ESD detection voltage.

24. The ESD protection circuit as recited in claim 23, wherein the first MOS transistor is a P-channel MOS transistor.

25. The ESD protection circuit as recited in claim 22, further comprising an auxiliary ESD detection voltage generating unit for providing the detection voltage to the trigger voltage generating unit in response to DC characteristics of the ESD, wherein the auxiliary ESD detection voltage generating unit is enabled in response to the trigger voltage.

26. The ESD protection circuit as recited in claim 25, further comprising an auxiliary trigger voltage generating unit coupled between the trigger voltage generating unit and a ground voltage terminal in order to increase a transition speed of the trigger voltage, wherein the auxiliary trigger voltage generating unit is enabled in response to the ESD detection voltage.

27. The ESD protection circuit as recited in claim 26, wherein the detection voltage generating unit includes:
a resistor having one terminal coupled to the power supply voltage terminal; and
a capacitor having one terminal coupled to the other terminal of the resistor and the other terminal coupled to the ground voltage terminal.

28. The ESD protection circuit as recited in claim 27, wherein the auxiliary detection voltage generating unit includes a second MOS transistor having one terminal coupled to the other terminal of the resistor, the other terminal coupled to the ground voltage terminal and a gate for receiving the trigger voltage.

29. The ESD protection circuit as recited in claim 28, wherein the second MOS transistor is an N-channel MOS transistor.

30. The ESD protection circuit as recited in claim 28, wherein the ESD discharge unit includes:
a PNP bipolar transistor having an emitter coupled to the power supply voltage terminal and a collector coupled to the node of the trigger voltage;
an NPN bipolar transistor having a collector coupled to a base of the PNP bipolar transistor, an emitter coupled to the ground voltage terminal and a base coupled to the collector of the PNP bipolar transistor;
a first resistor coupled between the base of the NPN bipolar transistor and the ground voltage terminal; and
a second resistor coupled between the collector of the PNP bipolar transistor and the power supply voltage terminal.

31. The ESD protection circuit as recited in claim 30, wherein the auxiliary trigger voltage generating unit includes a third MOS transistor having a gate coupled to a node of the ESD detection voltage, one terminal coupled to the node of the trigger voltage and the other terminal coupled to the ground voltage terminal.

32. The ESD protection circuit as recited in claim 31, wherein the third MOS transistor is an N-channel MOS transistor.
